(19) United States
(12) Patent Application Publication
(10) Pub. No.: US 2022/0034095 A1
(43) Pub. Date: Feb. 3, 2022

(54) EXTENDABLE RAIL SYSTEM FOR HELIPORTS

(71) Applicant: TROY BREAUX, RAYNE, LA (US)

(72) Inventor: TROY BREAUX, RAYNE, LA (US)

(21) Appl. No.: 17/503,336

(22) Filed: Oct. 17, 2021

Related U.S. Application Data
(63) Continuation-in-part of application No. 17/225,103, filed on Apr. 8, 2021.
Application No. 17/225,103 is a continuation-in-part of application No. 15/925,647, filed on Mar. 19, 2018, now abandoned.

(51) Int. Cl. E04F 11/18; B64F 1/30

(52) U.S. Cl. CPC E04F 11/1863; E04F 11/1836; E04F 2011/1876; E04F 2011/187; B64F 1/30

(57) ABSTRACT

An extendable rail system for a flight of stairs to exit a heliport comprising a railing positioned along the flight of stairs, where the railing includes a handrail; a plurality of anchors attached to the railing, where the plurality of anchors support the handrail; a rail extension attached to a top portion of the railing, where the rail extension moves between a first position and a second position; a motor coupled to the rail extension, where the motor moves the rail extension between the first position and the second position; a first actuator positioned on the heliport, where the first actuator activates the motor; and a second actuator positioned at a base of the railing, where the second actuator activates the motor.

### CROSS REFERENCE TO OTHER APPLICATIONS

This application is a continuation in part to U.S. patent application Ser. No. 17/225,106 filed on Apr. 8, 2021 and further continuation in part to U.S. patent application Ser. No. 15/925,647 filed on Mar. 19, 2018.

### BACKGROUND OF THE INVENTION

### Field of the Invention

The present invention relates to an extendable railing that extends and retracts along a staircase from a heliport.

### Description of Related Art

Because of the inherent dangers when traversing a flight of stairs, the recommended way to ascend or descend is with a three point contact protocol. This typically involves grabbing a railing, or pair of railings, and taking steps one at a time. The three points of contact ensure balance and maintain safety when climbing the stairs. This way the person always has a foothold or hand grab in case they slip or miss a step.

Heliports are increasingly being used in buildings like hospitals and hotels. They are useful because they provide a safe landing platform for a helicopter in locations where the helicopter typically cannot land; like a downtown or urban area where the flat open spaces or not readily available. The heliports typically have an opening that leads to a staircase beneath the platform. Because of helicopter safety, the railing does not extend above the heliport platform. Although their availability is growing, their safety protocols are lacking. While the three point protocol is the preferred method to walk safely down stairs, these new heliports do not have the proper provisions for the beginning the descent down the stairs. Many times the stairs include a railing that the person is only able to grab once they've traversed the first few stairs, therefore creating a nerve racking experience until the railing is reached.

Therefore it would be beneficial in the art to provide a railing for heliport stairs that remains beneath the heliport until needed. It would also be desirable for the railing to be easily accessible as the user approaches the stairs.

### SUMMARY OF THE INVENTION

In view of the foregoing disadvantages inherent in the prior art, the general purpose of the present invention is to provide an extendable rail system for a flight of stairs to exit a heliport, configured to include all of the advantages of the prior art, and to overcome the drawbacks inherent therein.

Accordingly, an object of the present invention is to provide an extendable rail system for a heliport, where a rail extension moves along a railing to provide a safety rail as a user initiates their descent from the heliport.

Another object of the present invention is to provide an extendable rail system with a motorized rail extension that is activated with a foot pedal positioned at the top of the stairs.

To achieve the above objects, in an aspect of the present invention, an extendable rail system for a flight of stairs is described comprising a railing positioned along the flight of stairs, where the railing includes a handrail; a plurality of anchors attached to the railing, where the plurality of anchors support the handrail; a rail extension attached to a top portion of the railing, where the rail extension moves between a first position and a second position; a motor coupled to the rail extension, where the motor moves the rail extension between the first position and the second position; a first actuator positioned on the heliport, where the first actuator activates the motor; and a second actuator positioned at a base of the railing, where the second actuator activates the motor.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a front ascending view of an extendable rail system according to the present invention.

FIG. 2 depicts a view of a moveable rail of the extendable rail system according to the present of invention.

FIG. 3 depicts a top descending view of the stairwell according to the presence of invention.

FIG. 4 depicts a view of the moveable rail from the inside and in accordance with the presence of invention.

### DETAILED DESCRIPTION OF THE DRAWINGS

The present invention relates to an extendable railing that extends and retracts along a staircase from a heliport. The present invention provides an extendable rail system for heliports to offer a user a device which affords support when traversing stairs that lead to and away from the heliport. The extendable rail system includes a 32-inch handrail coupled with a motor. The motor may utilize a pedal actuator to raise and lower the handrail thereby providing a readily available balance structure to the user as they descend the steps.

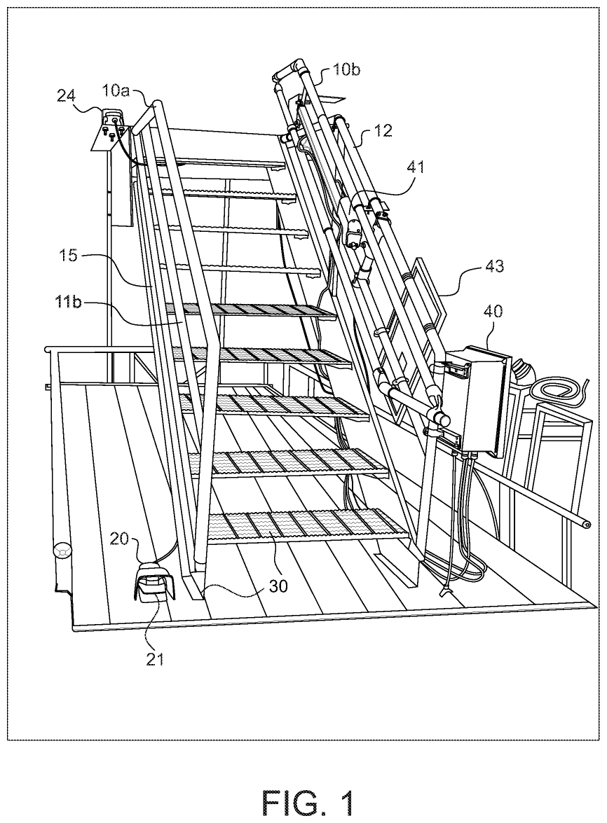

In reference to FIG. 1, a front view of an extendable rail system according to present invention use a stationary rail 10a and a moveable rail 10b. The stationary rail 10a is shown on one side of staircase 30. The moveable rail 10b is on the opposing side. The moveable rail 10b moves vertically and above the staircase 30. This movement enables the availability of the moveable rail 10b on a platform above staircase 30.

Adjacent to the moveable rail 10b is a second stationary rail 12. This rail 12 provides a brace for the movement of rail 10b, which is powered by a motor 41. This motor 41 receives power from a power supply 40 shown at the bottom of the staircase 30. The power supply 40 may receive AC or DC power or may be powered through a solar panel 43 as shown attached to the second stationary rail 12.

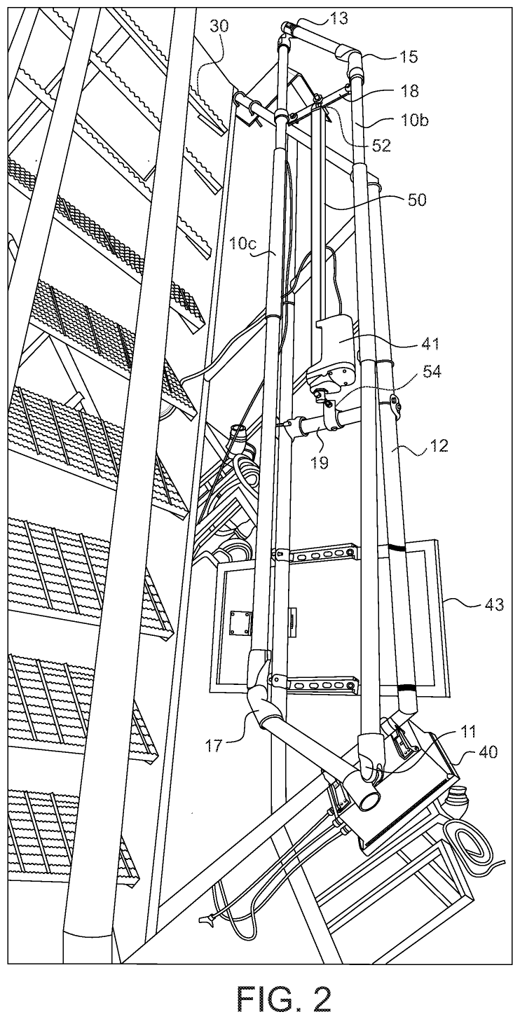

FIG. 2 depicts a more detailed view of the components related to the moveable rail 10b. The moveable rail 10b is attached to a telescope rail 50 that extends from motor 41. The motor 41 is braced to the second stationary rail 12 with a motor bracket 54 and telescope connector 52 attaches the telescoping rail 52 to a telescoping brace 18. The motor 41 is supported with the motor support 19 and motor bracket 54. During operation the telescoping rail 50 extends vertically at an angle consistent with the staircase 30 elevating the moveable rail 10b to a higher position above the top step. The moveable rail 10b has a first top rail connector 15 and a second top rail connector 13. Further a bottom rail connector 11 and a second bottom rail connector 17 is also shown to create the composite moveable rail 10b.

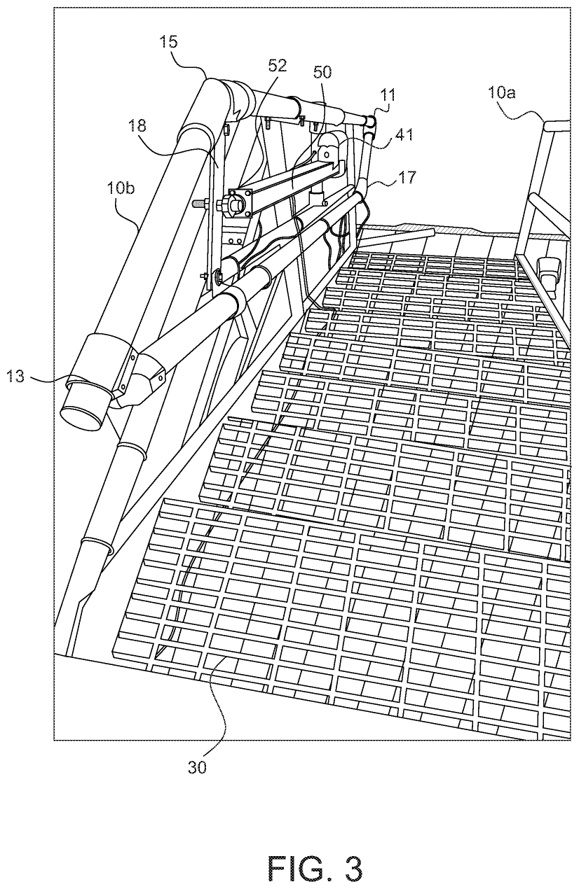

The stairwell 30 is show from a descending view in FIG. 3. This descending view shows the telescoping rail 50 and the attachment of a telescoping connector 52. This connector 52 moves the rail vertically and in both an upward and a downward position as desired by the user. Movement is actuated through the use of foot pedals 24 and 20. This enables the user to actuate the movement of the moveable rail 10b as needed.

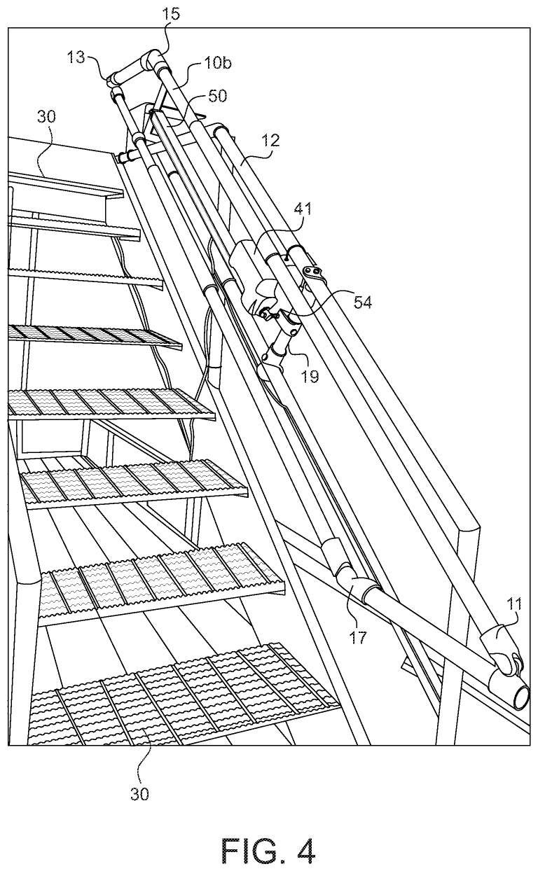

FIG. 4 provides another view of the moveable rail 10b. Here in this position the stationary rail 12 is shown without solar panel 43 or the electronic power supply 40. The motor 41 is preferably an electronic motor but also may be powered pneumatically or hydraulically.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An extendable rail system for a flight of stairs to exit a heliport comprising:
a. a railing positioned along the flight of stairs, where the railing includes a handrail;
b. a plurality of anchors attached to the railing, where the plurality of anchors support the handrail;
c. a rail extension attached to a top portion of the railing, where the rail extension moves between a first position and a second position;
d. a motor coupled to the rail extension, where the motor moves the rail extension between the first position and the second position;
e. a first actuator positioned on the heliport, where the first actuator activates the motor; and
f. a second actuator positioned at a base of the railing, where the second actuator activates the motor.

2. The extendable rail system according to claim 1, where the motor includes a power source.

3. The extendable rail system according to claim 2, where the power source is a battery.

4. The extendable rail system according to claim 3, where the battery includes a solar panel.

5. The extendable rail system according to claim 2, where the battery is a 12-volt battery.

6. The extendable rail system according to claim 1, where the railing is a pair of railings, one on each side of the flight of stairs.

7. The extendable rail system according to claim 1, where the first position positions the rail extension beneath the heliport.

8. The extendable rail system according to claim 1, where the second position positions the rail extension up to 42 inches above the heliport.

9. The extendable rail system according to claim 1, where the rail extension moves with a set of rollers within the railing.

10. The extendable rail system according to claim 9, where the set of rollers move along a liner within the railing.

11. The extendable rail system according to claim 1, where the railing includes a support rail positioned beneath the handrail.

12. The extendable rail system according to claim 1, where the first actuator includes a foot pedal.

13. The extendable rail system according to claim 1, where the first actuator includes a motion sensor.

14. The extendable rail system according to claim 1, where the second actuator includes a pair of buttons.
